(19) United States
(12) Patent Application Publication
(10) Pub. No.: US 2001/0048999 A1
(43) Pub. Date: Dec. 6, 2001

(54) REINFORCED FLEXIBLE SUBSTRATES AND METHOD THEREFOR

(76) Inventors: CHEN KUN-CHING, TAINAN (TW); TAO-YU CHEN, KAOHSIUNG (TW); YUNG-I YEH, KAOHSIUNG (TW); CHUN-CHE LEE, KAOHSIUNG (TW)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/044,034

(22) Filed: Mar. 19, 1998

(51) Int. Cl. B32B 3/10

(52) U.S. Cl. 428/131; 428/192; 428/209; 428/457; 428/458; 428/473.5

(57) ABSTRACT

A flexible substrate includes a substrate constructed in a form of a tape, the substrate including patterns formed on at least one of an upper side and a bottom side thereof. The tape includes sprocket holes defied in each of two lateral edges thereof. A supporting layer is applied to at least one of the upper side and the bottom side of the substrate at an area not covered by the patterns to reinforce the substrate.

### BACKGROUND OF THE INVENTION

1. Field of the Invention

The present invention relates to reinforced flexible substrates to allow stable delivery of ball-grid array integrated circuits. The present invention also relates to a method for manufacturing the reinforced flexible substrates.

2. Description of the Related Art

Ball-grid array integrated circuit (BGA IC) packaging method is one of the newly developed methods for ICs with a quantity of pins and is suitable for packaging integrated circuits of ultra-large scale integration (ULSI) produced by submicron resolution. When packaging, a mold is mounted on top of a BGA IC, and molten liquid plastic material (i.e., the package encapsulant) is then poured into the mold to completely enclose the integrated circuit chips on the substrate to thereby provide a completely air tight seal for the integrated circuit chips. The BGA IC is removed from the mold after the plastic material is hardened. A subsequent trim work is carried out on an area adjacent to a mold gate of the mold to remove the residual plastic material in a pouring channel of the mold. The mold includes a cavity which defines a space for molding.

A method for manufacturing a BGA IC includes: mounting chips on pre-set locations on a substrate of a printed circuit board of ball-grid array; proceeding with wire bonding by a suitable wire bonding method for connecting the chips with the conductive wires on the substrate; and packaging the printed circuit board. The method for packaging the printed circuit board has been described in the above paragraph.

In the above-mentioned packaging method for BGA ICs, a tape automatic bonding (TAB) of tape assembly technique uses reel to reel design, in which no solder ball is required, meanwhile, the TAB only requires connection between the inner lead bonding and outer lead bonding. Nevertheless, in addition to the wire bonding, solder balls are required for flexible substrates of BGA. As a result, problems has been arisen during delivery of the products, e.g., unstable delivery, unstable quality, and low productivity.

The present invention is intended to provide reinforced substrates which mitigate and/or obviate the above problems.

### SUMMARY OF THE INVENTION

It is an object of the present invention to provide a reinforced substrate which allows stable delivery thereof without any carrier.

In accordance with one aspect of the invention, a flexible substrate comprises a substrate constructed in a form of a tape, the substrate including patterns formed on at least one of an upper side and a bottom side thereof. The tape includes a plurality of sprocket holes defied in each of two lateral edges thereof. A supporting layer is applied to at least one of the upper side and the bottom side of the substrate at an area not covered by the patterns to reinforce the substrate.

In an embodiment of the invention, the supporting layer is made of copper foil. The substrate may be plastic and made of polyimide. In addition, the supporting layer is made of poly material or metallic material.

In accordance with another aspect of the invention, a flexible substrate comprises a substrate constructed in a form of a tape, the substrate including patterns formed on at least one of an upper side and a bottom side thereof. The tape includes a plurality of sprocket holes defied in each of two lateral edges thereof. A layer of copper foil is applied to the upper side of the substrate at an area not covered by the patterns. A supporting layer is applied to cover the copper foil and the bottom side of the substrate at an area not covered by the patterns to reinforce the substrate.

The present invention also provides a method for reinforcing a flexible substrate which comprises the steps of:

providing a substrate constructed in a form of a tape, the substrate including patterns formed on at least one of an upper side and a bottom side thereof, the tape including a plurality of sprocket holes defied in each of two lateral edges thereof, and

applying a supporting layer to at least one of the upper side and the bottom side of the substrate at an area not covered by the patterns to reinforce the substrate.

Other objects, advantages, and novel features of the invention will become more apparent from the following detailed description when taken in conjunction with the accompanying drawings.

### BRIEF DESCRIPTION OF THE DRAWINGS

FIG. 1 is a top view of a substrate in accordance with the present invention;

FIG. 2A is a sectional view, taken along line 2-2 in FIG. 1, illustrating a first embodiment of the present invention; and

FIGS. 2B and 2C are sectional views similar to FIG. 2A, illustrating modified embodiments of the present invention.

### DESCRIPTION OF THE PREFERRED EMBODIMENT

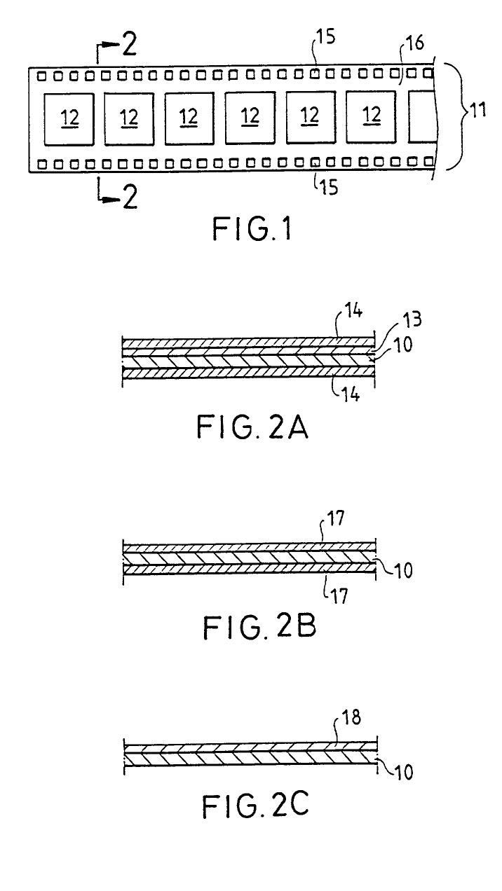

Referring to FIGS. 1 and 2 of the drawings, a flexible substrate 10 in accordance with the present invention is made of polyimide and constructed in the form of a tape 11 for delivery. The tape 11 includes patterns 12 formed thereon, and a supporting means 16 is provided on the tape 11 at an area not covered by the patterns 12 to reinforce the substrate 10 and to support the patterns 12. The supporting means 16 may include a layer of copper foil 13 and two supporting layers 14 respectively covered on an upper side of the copper foil 13 and a bottom side of the substrate 10. The supporting layer 14 is preferably made of poly material or metallic material to reinforce the substrate 10 so as to allow stable delivery of the substrate 10. The supporting layer 14 may be, e.g., a layer of adhesive tape or ink. In addition, sprocket holes 15 may be formed on two lateral edges of the tape 11, and the delivering device (not shown) may have corresponding teeth for engaging with the sprocket holes 15 for delivering the tape 11. Thus, during assembly of the tape 11, a stable delivery of the reinforced flexible substrate 10 in the form of a plastic ball-grid array (PBGA) can be attained at each assembly station.

FIG. 2B illustrates a modified embodiment, wherein the copper foil 13 can be etched. It is appreciated that the area covered by the patterns 12 are not etched. In addition, a supporting layer 17 of poly material or metallic material is applied to both sides of the substrate 10 on areas not covered by the patterns 12. Thus, the substrate 10 is reinforced by the supporting layers 17 to provide a stable delivery.

FIG. 2C illustrates a further modified embodiment of the present invention, wherein the copper foil (now designated by reference number “18”) is kept. Alternatively, a layer of metallic material may be applied to reinforce the substrate 10.

Although the invention has been explained in relation to its preferred embodiment, it is to be understood that many other possible modifications and variations can be made without departing from the spirit and scope of the invention as hereinafter claimed.

What is claimed is:

1. A flexible substrate, comprising:
a substrate constructed in a form of a tape, the substrate including patterns formed on at least one of an upper side and a bottom side thereof, the tape including a plurality of sprocket holes defied in each of two lateral edges thereof, and
a supporting layer applied to at least one of the upper side and the bottom side of the substrate at an area not covered by the patterns to reinforce the substrate.

2. The flexible substrate according to claim 1, wherein the supporting layer is made of copper foil.

3. The flexible substrate according to claim 1, wherein the substrate is plastic and made of polyimide.

4. The flexible substrate according to claim 1, wherein the supporting layer is made of poly material.

5. The flexible substrate according to claim 1, wherein the supporting layer is made of metallic material.

6. A flexible substrate, comprising:
a substrate constructed in a form of a tape, the substrate including patterns formed on at least one of an upper side and a bottom side thereof, the tape including a plurality of sprocket holes defied in each of two lateral edges thereof,
a layer of copper foil applied to the upper side of the substrate at an area not covered by the patterns, and
a supporting layer applied to cover the copper foil and the bottom side of the substrate at an area not covered by the patterns to reinforce the substrate.

7. The flexible substrate according to claim 6, wherein the substrate is plastic and made of polyimide.

8. The flexible substrate according to claim 6, wherein the supporting layer is made of poly material.

9. The flexible substrate according to claim 6, wherein the supporting layer is made of metallic material.

10. A method for reinforcing a flexible substrate, comprising the steps of:
providing a substrate constructed in a form of a tape, the substrate including patterns formed on at least one of an upper side and a bottom side thereof, the tape including a plurality of sprocket holes defied in each of two lateral edges thereof, and
applying a supporting layer to at least one of the upper side and the bottom side of the substrate at an area not covered by the patterns to reinforce the substrate.

11. The method according to claim 10, wherein the substrate is plastic and made of polyimide.

12. The method according to claim 10, wherein the supporting layer is made of poly material.

13. The method according to claim 10, wherein the supporting layer is made of metallic material.
